(19) United States
(12) Patent Application Publication
(10) Pub. No.: US 2014/0114529 A1
(43) Pub. Date: Apr. 24, 2014

(54) APPARATUS AND METHOD FOR ASSISTING PARKING IN AREA WITHOUT PARKING LINE

(71) Applicant: HYUNDAI MOTOR COMPANY, Seoul (KR)

(72) Inventors: Jun Sik An, Seongnam (KR); Joong Ryoul Lee, Hwaseong (KR); Kap Je Sung, Hwaseong (KR)

(73) Assignee: HYUNDAI MOTOR COMPANY, Seoul (KR)

(21) Appl. No.: 13/691,219

(22) Filed: Nov. 30, 2012

(30) Foreign Application Priority Data
Oct. 23, 2012 (KR) 10-2012-0117852

(51) Int. Cl. B60W 30/06

(52) U.S. Cl. CPC B60W 30/06
USPC 701/36

(57) ABSTRACT

Disclosed herein are an apparatus and a method for assisting parking on an area without a parking line. The apparatus includes a processor configured to: analyze a plurality of images obtained by photographing surroundings of a vehicle to detect distance information based on a ground surface in a vicinity of the vehicle; detect a plurality of obstacles in the vicinity of the vehicle based on a plurality of sensor values acquired by a plurality of sensors; determine a possible parking area in the area without a parking line in the vicinity of the vehicle based on the analysis of the plurality of images and the detected obstacles; set a selected area in the possible parking area as a parking area; and provide a parking assist service to the set parking area.

### CROSS-REFERENCE TO RELATED APPLICATION

This application is based on and claims priority under 35 U.S.C §119 (a) to Korean Patent Application No. 10-2012-0117852, filed on Oct. 23, 2012 in the Korean Intellectual Property Office, the disclosure of which is incorporated herein in its entirety by reference.

### BACKGROUND OF THE INVENTION

1. Field of the Invention

The present invention relates to an apparatus and a method for assisting parking in an area without a parking line, and more particularly, to an apparatus and a method for guiding a vehicle to a possible parking area which is not designated in a parking line and providing a parking assist service to a selected parking area.

2. Description of the Prior Art

Generally, many drivers find it difficult to park a vehicle within parking lines designated as a parking area. Recently, a vehicle has been developed to include a parking assist system that enables a driver to easily park a vehicle, in which the parking assist system may help a driver to detect surroundings of a vehicle and to park a vehicle in a specific parking space using the detected results.

A system has been developed for detecting a parking area by detecting edges, and the like, of a parking line using an imaging device during the parking of a vehicle and searching an empty parking area based on a shape of a parking line, and the like, to provide a parking assist service for parking a vehicle in a corresponding parking area.

However, since most of the parking assist systems search a possible parking area based on a parking line, and the like, when a driver parks a vehicle in a parking lot without a parking line, a vacant lot, and the like, the difficulty in parking a vehicle remains

### SUMMARY OF THE INVENTION

Accordingly, the present invention provides an apparatus and a method for assisting parking in an area without a parking line capable of guiding a vehicle to a possible parking area without a parking line and providing a parking assist service to a selected parking area.

The present invention is further provides an apparatus and a method for assisting parking in an area without a parking line capable of guiding a vehicle toward a possible parking area without an interference concern of adjacent vehicles in an area without a parking line.

In one embodiment of the present invention, an apparatus for assisting parking in an area without a parking line, may include a plurality of units executed by a processor within a controller having a memory. The plurality of units may include: an image analyzing unit that analyzes images obtained by photographing surroundings of a vehicle to detect distance information based on a ground surface in the vicinity of the vehicle; an obstacle detecting unit that detects obstacles in the vicinity of the vehicle based on sensor values acquired by a plurality of sensors mounted in the vehicle; a possible parking area determining unit that determines a possible parking area in the area without a parking line in the vicinity of the vehicle from the analysis results of the surrounding images and the obstacle detecting results; and a parking assist processing unit that sets a selected area in the possible parking area as a parking area and provides a parking assist service to the set parking area.

The possible parking area determining unit may estimate a moving path of nearby vehicles in the vicinity of the vehicle to exclude an area in which a part or the entirety of the possible parking area overlaps the moving path in the vicinity of the vehicle. The parking assist processing unit may further set an area selected by a driver in the possible parking area as a parking area.

The parking assist processing unit may display a virtual vehicle image of the vicinity of the vehicle in a parking complete guide image of the vehicle when the vehicle is parked in the parking area.

In another embodiment of the present invention, a method for assisting parking in an area without a parking line, may include: analyzing, by a processor, images obtained by photographing surroundings of a vehicle to detect distance information based on a ground surface in the vicinity of the vehicle; detecting, by the processor, obstacles in the vicinity of the vehicle based on sensor values acquired by a plurality of sensors mounted in the vehicle; determining, by the processor, a possible parking area in the area without a parking line in the vicinity of the vehicle from the analysis results of the surrounding images and the obstacle detecting results; and setting, by the processor, a selected area in the possible parking area as a parking area and providing a parking assist service to the set parking area.

In determining the possible parking area, a moving path of nearby vehicles in the vicinity of the vehicle may be estimated to exclude an area in which a part or the entirety of the possible parking area overlaps the moving path in the vicinity of the vehicle.

In providing the parking assist service, an area selected by a driver in the possible parking area may be set as a parking area.

The method for assisting parking in an area without a parking line may further include: displaying a virtual vehicle image of the vicinity of the vehicle in a parking complete guide image of the vehicle when the vehicle is parked in the parking area.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram illustrating an apparatus for assisting parking without a parking line according to an exemplary embodiment of the present invention;

FIG. 2 is an exemplary block diagram illustrating a configuration of the apparatus for assisting parking without a parking line according to an exemplary embodiment of the present invention;

FIGS. 3 to 8 are exemplary diagrams illustrating an operation of the apparatus for assisting parking without a parking line according to an exemplary embodiment of the present invention; and

FIG. 9 is an exemplary flow chart illustrating a method for assisting parking without a parking line according to an exemplary embodiment of the present invention.

### DETAILED DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present invention will be described in detail with reference to the accompanying drawings.

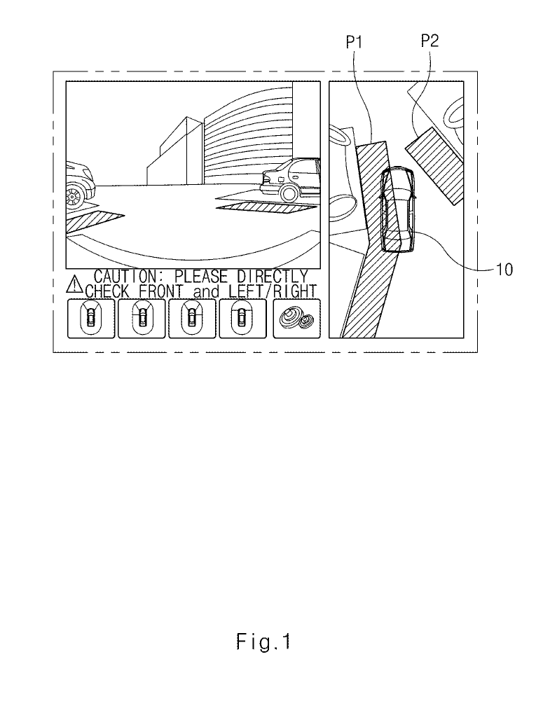

FIG. 1 is an exemplary diagram illustrating an apparatus for assisting parking without a parking line according to an exemplary embodiment of the present invention.

Referring to FIG. 1, an apparatus, executed by a processor, (hereinafter, referred to as ‘parking assist apparatus’) for assisting parking in an area without a parking line according to an embodiment of the present invention may provide a possible parking area in an area without a parking line using a display or a navigation screen mounted in a vehicle 10 and may provide a parking assist service to a selected possible parking area. In particular, the area without a parking line means an area that is not designated with a parking line.

Furthermore, the parking assist apparatus may estimate a moving path of nearby vehicles in the area without a parking line to provide an area without interference concern of the moving path of the nearby vehicles as a possible parking area. As such, the parking assist apparatus according to the embodiment of the present invention may help a driver to quickly and safely park a vehicle in an area without a parking line, when there is no parking area designated as a parking line or there is no empty area in a parking area designated as a parking line.

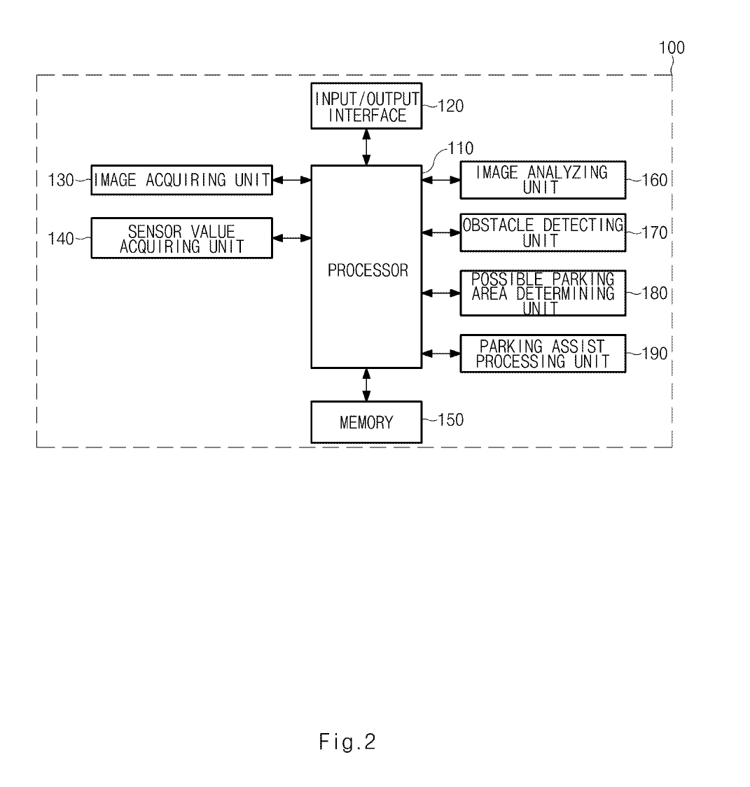

Hereinafter, a detailed configuration of the parking assist apparatus will be described with reference to an embodiment of FIG. 2.

FIG. 2 is an exemplary block diagram illustrating a configuration of the apparatus for assisting parking on an area without a parking line according to an exemplary embodiment of the present invention.

Referring to FIG. 2, a parking assist apparatus 100 (e.g., a controller) according to an embodiment of the present invention may include a plurality of units executed by a processor 110 within a controller 100 having a memory 150. The plurality of units may include: an input and output interface 120, an image acquiring unit 130, a sensor value acquiring unit 140, an image analyzing unit 160, an obstacle detecting unit 170, a possible parking area determining unit 180, and a parking assist processing unit 190. Furthermore, the processor 110 may control an operation of each unit of the parking assist apparatus 100 according to the embodiment of the present invention.

The input and output interface 120 is a unit that may receive a control command of a user or may output an operation state and result of the parking assist apparatus 100 and may be implemented by an apparatus in which an input unit and an output unit such as a touch screen are integrated and an apparatus in which an input unit and an output unit are separately formed. In particular, the input and output interface 120 may display a possible parking area or may provide a parking assist service when a driver parks a vehicle in an area without a parking line. Further, the input and output interface 120 may receive the parking area selected by a driver.

The image acquiring unit 130 may be connected to a plurality of imaging devices mounted in a vehicle to acquire an image photographed by the plurality of imaging devices. For example, the image acquiring unit 130 may be connected to each imaging device mounted at a front, a back, a left, and a right of a vehicle to capture front, back, left, and right images photographed by each imaging device. Further, the image acquiring unit 130 may be connected to an AVM system to capture an AVM image used in the AVM system.

The sensor value acquiring unit 140 may be connected to a plurality of sensors mounted in a vehicle to acquire sensor values detected by a plurality of sensors. Here, the plurality of sensors may include a plurality of sensors mounted in a vehicle to detect environment information in the vicinity of a vehicle, and the like, such as a sensor detecting a location and a distance of nearby vehicles, persons, obstacles, and the like, that are located at the front, back, left, and right of the vehicle, a parking line detecting sensor, and the like. Moreover, the sensor values acquired by the corresponding sensors may be used to detect a possible parking area in an area without a parking line or may be used to provide the parking assist service.

The memory 150 may store information acquired by the image acquiring unit 130 and the sensor value acquiring unit 140. In addition, the memory 150 may store an initial setting value, operation data, and the like, for operation of the parking assist apparatus 100. For example, the memory 150 may store a condition value set to determine the possible parking area, a setting value for providing a parking assist service, and the like.

Further, the memory 150 may store information on the vehicle. For example, the memory 150 may store information regarding a length and a width of a vehicle. Specifically, the vehicle information stored in the memory 150 may be used to determine a possible parking area later.

The image analyzing unit 160 may analyze surrounding images acquired by the image acquiring unit 130. Furthermore, the image analyzing unit 160 may analyze a plurality of images obtained by photographing surroundings of a vehicle to detect distance information based on a ground surface in a surrounding area of a vehicle. In particular, the image analyzing unit 160 may detect coordinate information on a reference point of an area in which a vehicle is parked.

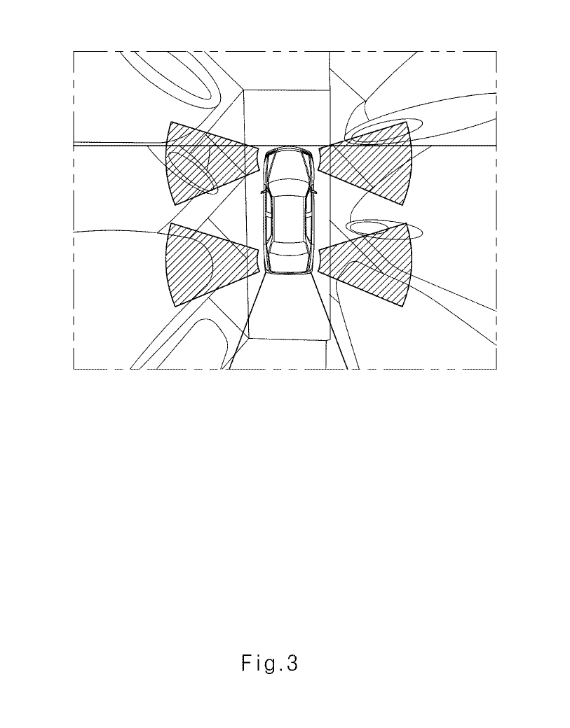

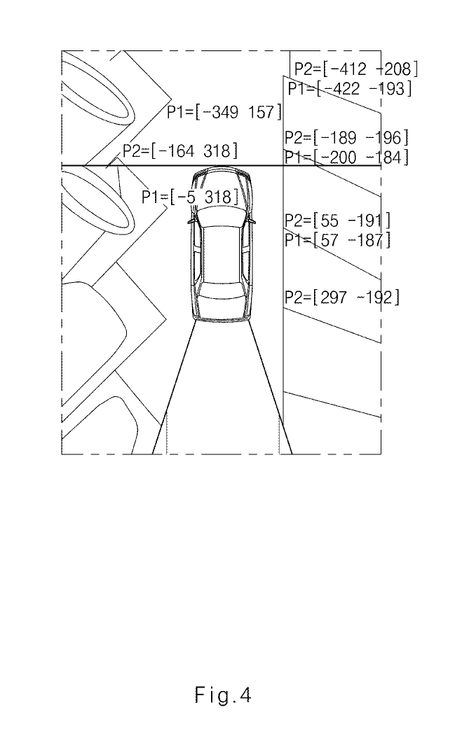

An embodiment in which the image analyzing unit 160 analyzes the distance information based on the ground surface of the surrounding image will be described with reference to FIGS. 3 and 4.

The obstacle detecting unit 170 may detect a plurality of obstacles located in the vicinity of a vehicle based on image analysis results by the image analyzing unit 160 and the sensor values acquired by the sensor value acquiring unit 140. Furthermore, the obstacle detecting unit 170 may detect the location and distance information, and the like, of the plurality of obstacles.

The possible parking area determining unit 180 may be used to determine the possible parking area based on the image analysis results by the image analyzing unit 160 and the obstacle detecting results by the obstacle detecting unit 170. Furthermore, the possible parking area determining unit 180 may determine a possible parking area in the vicinity of a vehicle based on the analysis results of the surrounding images and the obstacle detecting results. In particular, the possible parking area determining unit 180 may determine the possible parking area in an area without a parking line in the vicinity of a vehicle.

Moreover, the area without a parking line may not be a parking area limited by a parking line and may, alternatively be a moving path of a second vehicle. Therefore, the possible parking area determining unit 180 may primarily search the possible parking area in the vicinity of the first vehicle from the analysis results of the surrounding images and the obstacle detecting results and may estimate the moving path of the second vehicle to exclude an area in which a section of the possible parking area or the entire possible parking area overlaps the estimated moving path of the second vehicle in the previously searched possible parking area. Additionally, the remaining possible parking area may be determined as a final possible parking area.

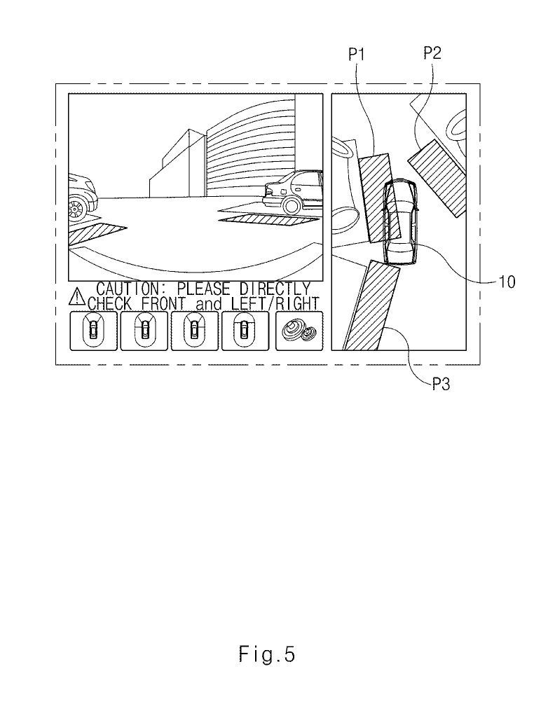

Moreover, the possible parking area determining unit 180 may determine a possible parking area using vehicle information, such as the length and width information of a vehicle. In particular, the possible parking area determining unit 180 may provide the information on the final possible parking area to a driver through a screen of the input and output interface 120. The embodiment providing the information on the possible parking area to a driver will be described with reference to FIG. 5.

In particular, the driver may select a desired parking area based on the information on the possible parking area provided through the screen of the input and output interface 120. The parking assist processing unit 190 may set the selected area in the possible parking area as the parking area. In other words, when a driver selects any area in the possible parking area, the parking assist processing unit 190 may set the area selected by a driver as a parking area. Furthermore, the parking assist processing unit may provide a parking assist service so the vehicle may be parked in the set parking area.

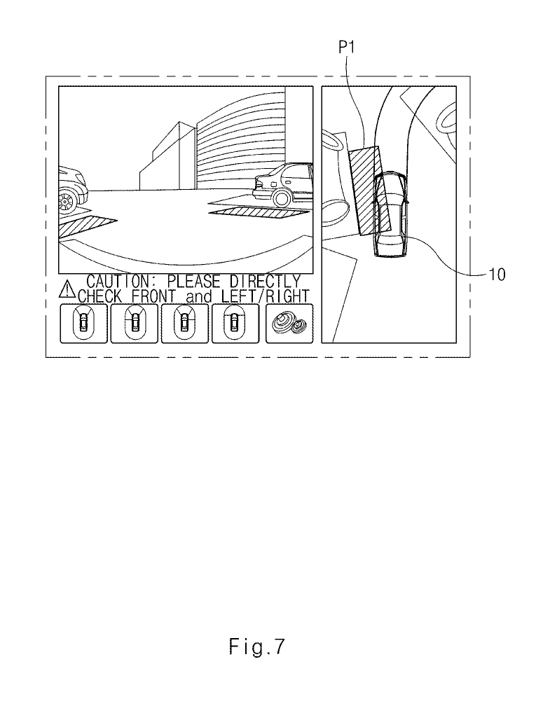

The embodiment providing the parking assist service to the set parking area will be described with reference to FIG. 7.

Specifically, the parking assist service may be a service providing parking convenience and a parking guide line, a distance from surrounding obstacles, surrounding images, and the like, during the parking based on a set parking area, a location and a direction of a current vehicle, and the like, such that a driver may safely park a vehicle. The parking assist service may use a conventionally used algorithm and therefore, the detailed description thereof will be omitted.

Moreover, the parking assist processing unit 190 may output a parking complete guide image through the input and output interface when a vehicle is parked in the set parking area. In particular, the parking assist processing unit 190 may display a virtual vehicle in the vicinity of the corresponding vehicle on the parking complete guide image output through the input and output interface 120, such that a driver may view the estimated moving path of a nearby vehicle, and the like.

FIGS. 3 to 8 are exemplary diagrams illustrating an operation of the apparatus for assisting parking in an area without a parking line according to an exemplary embodiment of the present invention.

FIGS. 3 and 4 illustrate an embodiment that may acquire and analyze information in the vicinity of a first vehicle to search a possible parking area. In particular, as illustrated in FIG. 3, the parking assist apparatus may acquire a plurality of images in the vicinity of the first vehicle photographed by the imaging devices and the sensor values detected by the plurality of sensors to analyze the ground surface from the images in the vicinity of the first vehicle, thereby acquiring the distance information based on the ground surface, and the like. In addition, the parking assist apparatus may analyze the acquired sensor values to detect the location and distance information, and the like, on obstacles in the vicinity of the first vehicle.

Therefore, as illustrated in FIG. 4, the parking assist apparatus may detect relative coordinates of each end of a parking line at which a second vehicle in the vicinity of a first vehicle is parked. The parking assist apparatus may detect the length and width of the area in which a vehicle is not parked by using the detected coordinate information and the position information of obstacles detected from the information detected by the plurality of sensors as illustrated in FIG. 4.

Moreover, the parking assist apparatus may not search only the space in which a vehicle may be parked but may also estimate a moving path, and the like, according to the movement of a second vehicle and may search the possible parking area in consideration of the estimated moving path.

FIG. 5 illustrates an example in which the information on the possible parking area may be provided through the screen of the input and output interface. Referring to FIG. 5, when the parking assist apparatus determines the possible parking area using the embodiments of FIGS. 3 and 4, the parking assist apparatus may provide the possible parking areas through the screen of the input and output interface for the driver to select a desired parking area.

For example, as illustrated in FIG. 5, when the possible parking area in the vicinity of the current vehicle 10 is P1, P2, and P3, the areas corresponding to the P1, P2, and P3 may be displayed on the screen of the input and output interface. Furthermore, the searched possible parking area may be displayed as a top view image of the vehicle 10 and a vehicle image based on the location of the current vehicle 10 may also be displayed on the screen on which the searched possible parking area is provided.

Although not illustrated in FIG. 5, the detailed information on each possible parking area and the detailed information on the possible parking area may be displayed on the screen of the input and output interface when the driver selects the possible parking area.

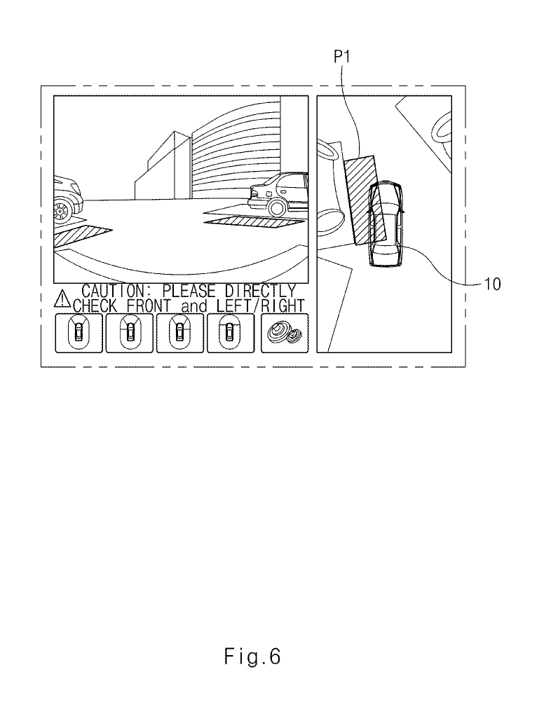

FIG. 6 illustrates an operation of selecting the possible parking area selected by a driver as a parking area among three possible parking areas illustrated in FIG. 5. Referring to FIG. 6, when the driver selects P1 among the possible parking areas P1, P2, and P3, the selected P1 may be set as the parking area. Furthermore, the parking assist apparatus may eliminate the non-selected P2 and P3 parking areas on the screen of the input and output interface for the selected P1 to be displayed together with the image of the corresponding vehicle 10. The possible parking areas P1, P2, and P3 may be displayed with various colors, brightness, size, and the like, on the input and output interface.

FIG. 7 illustrates an example of providing the parking assist service to the parking area set in FIG. 6. Referring to FIG. 7, the parking assist apparatus may display the parking guide line, and the like, on the screen of the input and output interface so the corresponding vehicle 10 may be parked in the P1 set as the parking area in consideration of the detailed information of the parking area P1. In other words, the information such as a location, a length, a width, the location of the current vehicle 10, may be used as the detailed information of the parking area P1 thereby enabling a user to rapidly and conveniently park the vehicle. Furthermore, the parking assist apparatus may provide the parking guide information based on the real-time location of the corresponding vehicle 10 according to the movement of the location of the vehicle 10.

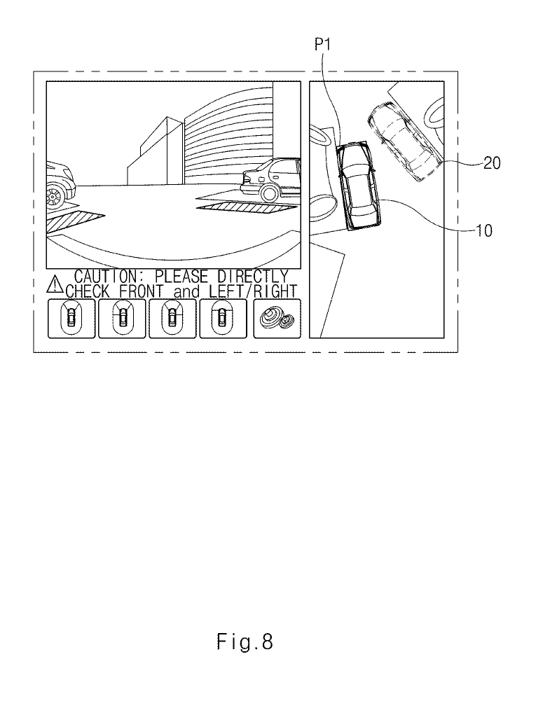

FIG. 8 illustrates an example of displaying a virtual vehicle image when a vehicle is parked in the set parking area. Referring to FIG. 8, when the vehicle 10 is parked in P1 set as the parking area, the virtual vehicle image may be generated displayed in the vicinity of the corresponding vehicle image so a driver may view the moving path of another vehicle.

In other words, when the first vehicle 10 is parked in the parking area P1, the virtual vehicle image may generate and display the area around the vehicle to illustrate whether a second vehicle may pass the area, thereby illustrating a more reliable parking location.

The method of the parking assist apparatus in an area without a parking line according to the embodiment of the present invention configured as described above will be described in more detail.

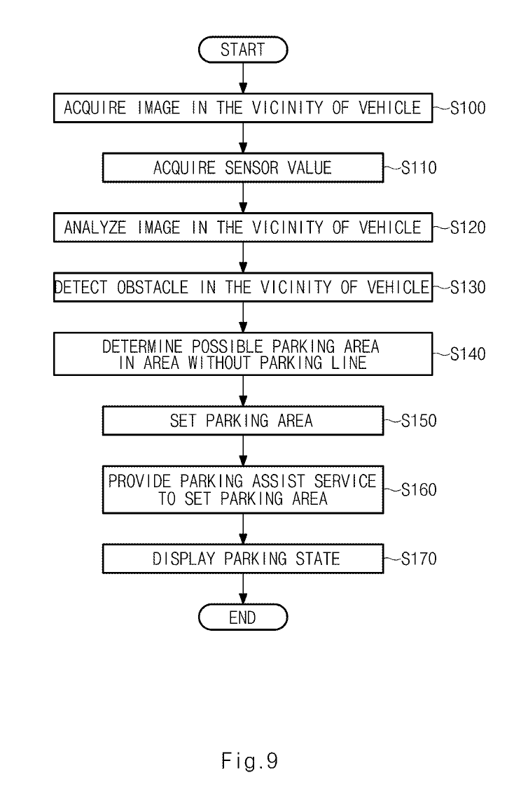

FIG. 9 is an exemplary flow chart illustrating a method for assisting parking in an area without a parking line according to another embodiment of the present invention. In particular, FIG. 9 illustrates an operation of searching and guiding the possible parking area in an area without a parking line when a first vehicle is parked in the area without a parking line that is not designated as a parking area.

Referring to FIG. 9, the parking assist apparatus according to the embodiment of the present invention may acquire, by processor, a plurality of images and sensor values in the vicinity of a first vehicle to search the possible parking area when attempting to park the first vehicle in an area without a parking line (S100, S110). Furthermore, the surrounding images may be images in to the vicinity of the first vehicle and images of a ground surface and the sensor values may be the surrounding environment information detected by the plurality of sensors mounted in a vehicle.

The parking assist apparatus may analyze, by the processor, images in the vicinity of the first vehicle acquired in S100 and may detect obstacles in the vicinity of the first vehicle based on the acquired sensor values. Furthermore, the parking assist apparatus may determine, by the processor, a possible parking area in the area without a parking line in the vicinity of the first vehicle based on the analysis results of the surrounding images in S120 and the obstacle detecting results in S130 (S140). In determining the possible parking area in S140, the moving path of a second vehicle may be estimated, by the processor, to confirm the area that does not interfere with the estimated moving path of a second vehicle in the possible parking area.

The information on the possible parking area confirmed in S140 may be displayed to a user through a display screen. Additionally, when a driver selects a possible parking area, the parking assist apparatus may set the possible parking area selected by a driver as a parking area (S150).

When the parking are is set in S150, the parking assist apparatus may provide, by the processor, a parking assist service so the first vehicle may be parked in the set parking area (S160). When the first vehicle is parked in the set parking area, the parking complete state of the corresponding vehicle may be displayed on the display screen (S170). Furthermore, when a driver intends to park a vehicle in the area without a parking line, the parking assist apparatus may generate a virtual vehicle image and illustrating the area in the vicinity of the corresponding vehicle, thereby recognizing an area that does not interfere with the moving path of a second vehicle.

The embodiments of the present invention may automatically determine the possible parking area in an area without a parking line when a driver parks a first vehicle in the area without a parking line and may provide the parking assist service to the selected parking area to assist the rapid and safe parking. Further, the embodiments of the present invention may guide a vehicle to a possible parking area without the interference concern of a moving path of nearby vehicles in the area without a parking line, so the driver can safely park a vehicle.

As described above, the apparatus and method for assisting parking in an area without a parking line are described with reference to the illustrated drawings, but the present invention is no limited to the embodiments and the drawings disclosed in the present specification and therefore, can be modified within the scope of the technical scope of the present invention.

1. An apparatus for assisting parking in an area without a parking line, comprising:
a processor configured to:
analyze a plurality of images obtained by photographing surroundings of a vehicle to detect distance information based on a ground surface in a vicinity of the vehicle;
detect a plurality of obstacles in the vicinity of the vehicle based on a plurality of sensor values acquired by a plurality of sensors mounted in the vehicle;
estimate a moving path of nearby vehicles in the vicinity of the vehicle;
determine, from the plurality of images, a plurality of possible parking areas in the area without a parking line in the vicinity of the vehicle based on the analysis of the plurality of images, the detection of the plurality of obstacles and the estimation of the moving path of nearby vehicles;
display the plurality of possible parking areas on a screen;
select a parking area from the plurality of possible parking areas by a driver;
provide a parking assist service to the selected parking area; and
remove other possible parking areas of the plurality of possible parking areas from the screen.

2.-3. (canceled)

4. The apparatus according to claim 1, wherein the processor is further configured to display a virtual vehicle image of the vicinity of the vehicle in a parking complete guide image of the vehicle when the vehicle is parked in the parking area.

5. A method for assisting parking without a parking line, comprising:
analyzing, by a processor, a plurality of images obtained by photographing surroundings of a vehicle to detect distance information based on a ground surface in a vicinity of the vehicle;
detecting, by the processor, a plurality of obstacles in the vicinity of the vehicle based on a plurality of sensor values acquired by a plurality of sensors mounted in the vehicle;
estimating, by the processor, a moving path of nearby vehicles in the vicinity of the vehicle;
determining, by the processor, from the plurality of images, a plurality of possible parking areas in the area without a parking line in the vicinity of the vehicle based on the analysis of the plurality of images, the detected obstacles and the estimated moving path of the nearby vehicles;
displaying the plurality of possible parking areas on a screen;
selecting a parking area from the plurality of possible parking areas by a driver;
providing, by the processor, a parking assist service to the selected parking area; and
removing other possible parking areas of the plurality of possible parking areas from the screen.

6.-7. (canceled)

8. The method according to claim 5, further comprising:
displaying, by the processor, a virtual vehicle image of the vicinity of the vehicle in a parking complete guide image of the vehicle when the vehicle is parked in the parking area.

9. A non-transitory computer readable medium containing program instructions executed by a processor or controller, the computer readable medium comprising:
program instructions that analyze a plurality of images obtained by photographing surroundings of a vehicle to detect distance information based on a ground surface in a vicinity of the vehicle;
program instructions that detect a plurality of obstacles in the vicinity of the vehicle based on a plurality of sensor values acquired by a plurality of sensors mounted in the vehicle;
program instructions that estimate a moving path of nearby vehicles in the vicinity of the vehicle;
program instructions that determine from the plurality of images, a plurality of possible parking areas in the area without a parking line in the vicinity of the vehicle based on the analysis of the plurality of images, the detection of the plurality of obstacles and the estimation of the moving path of the nearby vehicles;
program instructions that display the plurality of possible parking areas on a screen;
program instructions that select a parking area from the plurality of possible parking areas in response to a driver selection;
program instructions that provide a parking assist service to the selected parking area; and
program instructions that remove other possible parking areas of the plurality of possible parking areas from the screen.

10.-11. (canceled)

12. The computer readable medium of claim 9, further comprising program instructions that display a virtual vehicle image of the vicinity of the vehicle in a parking complete guide image of the vehicle when the vehicle is parked in the parking area.
